(19) United States
(12) Patent Application Publication
(10) Pub. No.: US 2004/0167949 A1
(43) Pub. Date: Aug. 26, 2004

(54) Data saturation manager and corresponding method

(76) Inventors: Hyun-Woo Park, Suwon-city (KR); Kee-Won Joe, Yongin-city (KR); Keun-Cheol Hong, Suwon-city (KR)

Correspondence Address: HARNESS, DICKEY & PIERCE, P.L.C., P.O. BOX 8910, RESTON, VA, 20195, US

(21) Appl. No.: 10/778,070

(22) Filed: Feb. 17, 2004

(30) Foreign Application Priority Data
Feb. 26, 2003 (KR) 2003-12042

(51) Int. Cl. G06F 15/00

(52) U.S. Cl. 708/207

(57) ABSTRACT

A data saturation manager may include: a validity bit deciding circuit to generate boundary value data based upon a boundary value; a saturation detecting circuit to determine whether received data is saturated according to the boundary value data, and to output a detection signal as a result; a limit generating circuit to generate a maximum limit and a minimum limit based upon the boundary value data; and a selecting circuit to output one among the received data, the maximum limit and the minimum limit according to the received data and the detection signal.

### CROSS REFERENCE TO RELATED APPLICATION

This application claims the priority of Korean Patent Application No. 2003-12042, filed on Feb. 26, 2003 in the Korean Intellectual Property Office, the disclosure of which is hereby incorporated by reference in its entirety.

### BACKGROUND OF THE INVENTION

Data saturation management has been widely used to delimit complex operation results of a signal processing system, such as energy calculation or coherent accumulation results, which can produce intermediary or final results of calculation that exceed a magnitude that can be represented. For example, a 16-bit signal processor can represent a result in the range from 0 to 65,535 (unsigned) or from −32,768 to 32,767 (signed). Hence, an operation result of the 16-bit signal processor which is less than −32,768 or more than 32,767 cannot be represented.

When the operation result (again, assuming a 16-bit signal processor) does not fall within the range from 0×8000 hexadecimal (decimal −32,768) to 0×7FFF hexadecimal (decimal 32,767), a saturation management apparatus informs a user and/or clips the out-of-range result to a maximum value (32,767) or a minimum value (−32,768) of the range. Subsequent calculations based upon an out-of-range or clipped result can be unreliable.

An operation result that is out of range is generally referred to as overflow occurrence. Clipping the out-of-range result to a maximum or minimum is generally referred to as a saturation management method.

FIG. 1 illustrates a table for explaining saturation management for 16-bit data according to the Background Art. In FIG. 1, X is an operation result and Y is an output. When X is more than the maximum value 32,767, then Y is clipped to 32,767. When X is less than the minimum value −32,768, then Y is clipped to −32,768. When X is presented in the range from −32,768 to 32,767, then Y is equal to X.

In most cases, such saturation management is performed using a program, and execution of the program extends over several cycles, which is time-consuming.

If such saturation management is implemented in hardware, a large layout size is needed. In addition, when the user defines a specific range that can be represented, the specific range is fixed in the hardware, which prevents the user from changing the representable range even when application requirements change or the user desires to change the representable range.

FIG. 2 illustrates an example of software code for implementing saturation management, according to Background Art. The implementation functions are generalized versions of the saturation management of FIG. 1, namely: if X is more than an upper bound, then Y is clipped to the upper bound; if X is less than a lower bound, then Y is clipped to the lower bound; and if X lies within a range from the lower bound to the upper bound, then Y is equal to X. The example of saturation management in FIG. 2 needs about 4-5 processor cycles to completion execution. In a mobile communication system such as the universal mobile telecommunication system (UMTS), saturation management is frequently performed during coherent accumulation and non-coherent accumulation. Currently, the few cycles needed for saturation management has little negative impact on the mobile communication system, but may become a significant computations burden on the mobile communication system as other applications (representing other computational loads) are added to the mobile communication system.

FIG. 3 is a block diagram illustrating a saturation management apparatus 300 according to the Background Art which implements in hardware the generalized functions of FIG. 2.

Saturation management apparatus 300 includes a 2's complement calculator 310, a subtractor 320, comparators 330 and 340, and a selecting unit (or multiplexer, hereafter MUX) 350.

A boundary value BV indicates a maximum value that a data signal DATA can validly represent. Boundary value BV can be set by a user. Data signal DATA is the result of some data processing operation (not shown). Boundary value BV is applied to 2's complement calculator 310 and subtractor 320 (which subtracts one from BV).

For example, if boundary value BV is 2⁸, validity values of data signal DATA range from −2⁷ to 2⁷−1. When data overflow occurs, output signal SATRST is clipped to the value −2⁷ or 2⁷−1. In more detail, comparator 330 compares data signal DATA with the difference value 2⁷−1 output from subtractor 320. Comparator 340 compares data signal DATA with the minimum value −2⁷ output from the 2's complement calculator 310. MUX 350 outputs one among data signal DATA, the maximum value 2⁷−1, and the minimum value −2⁷, according to outputs of comparators 330 and 340.

Saturation management apparatus 300 requires only 3 clock cycles but the range of validity data signal DATA is fixed by a specific value, i.e., −2⁷ and 2⁷−1. Circuitry to permit dynamic change of the validity range of data signal DATA can be provided, but that increases the footprint of saturation management apparatus 300.

### SUMMARY OF THE PRESENT INVENTION

Embodiments of the present invention provide an apparatus which manages data saturation or (in other words) a data saturation manager. Such an apparatus can be implemented with a simple circuit configuration and can allow a user to dynamically set the range of validity operation results.

Embodiments of the present invention also provide a method of managing data saturation, which can be implemented by the data saturation manager mentioned above.

### BRIEF DESCRIPTION OF THE DRAWINGS

The above and other aspects and advantages of the present invention will become more apparent by describing in detail an example embodiment thereof with reference to the attached drawings in which:

FIG. 1 is a table for explaining saturation management in 16-bit data according to Background Art;

FIG. 2 is an example of software implementing saturation management according to Background Art;

FIG. 3 is a block diagram illustrating a saturation management apparatus according to the Background Art;

FIG. 4 is a block diagram illustrating a saturation manager according to an embodiment of the present invention;

FIG. 5 is a circuit diagram illustrating in more detail an example of the validity bit deciding unit of FIG. 4, according to an embodiment of the present invention;

FIG. 6 is a table for explaining determination of data saturation according to an example implementation of an embodiment of the present invention;

FIG. 7 is a block diagram illustrating in more detail an example of the saturation detecting unit of FIG. 4, according to an embodiment of the present invention;

FIG. 8 is a circuit diagram illustrating in more detail an example of the limit generating unit of FIG. 4, according to an embodiment of the present invention;

FIG. 9 is a table for explaining the operation of a selecting unit, according to an embodiment of the present invention;

FIG. 10A shows the results of testing the operating speed of the saturation management apparatus of Background Art FIG. 3;

FIG. 10B shows the results of testing the operating speed of an example implementation of an apparatus which manages saturation according to an embodiment of the present invention; and

FIG. 11 is a flowchart describing a method of managing saturation according to an embodiment of the present invention.

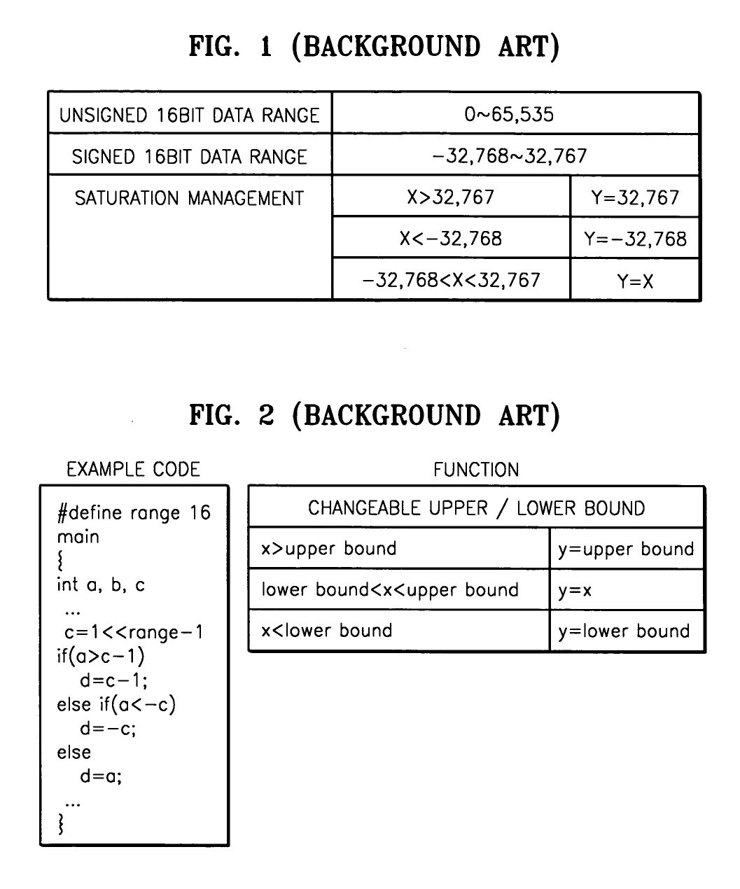

### DETAILED DESCRIPTION OF THE PRESENT INVENTION

The present invention will now be described more fully with reference to the accompanying drawings. Identical reference numerals have been used, where possible, to designate identical elements that are common in the figures.

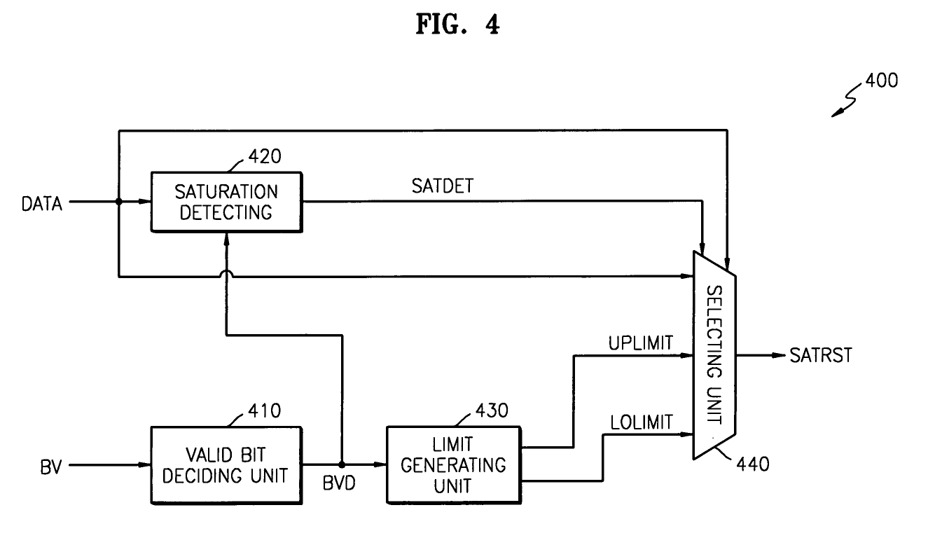

FIG. 4 is a block diagram illustrating an apparatus 400 which manages saturation according to an embodiment of the present invention.

Saturation manager 400 includes a validity bit deciding unit 410, a saturation detecting unit 420, a limit generating unit 430, and a selecting unit 440.

In response to a boundary value BV, validity bit deciding unit 410 generates boundary value data BVD which indicates those bits in a data signal DATA that are validity bits. Data BVD can be used to determine whether data signal DATA is saturated.

Boundary value BV can be expressed using fewer bits than the number of bits corresponding to the width of a data bus for a processor (not shown) in which is incorporated saturation manager 400. If a processor incorporating saturation manager 400 includes a data bus of K bits and boundary value BV is expressed as 2^{A}, the number of validity bits corresponds to the upper (K−A) bits of data BVD.

If boundary value BV is defined as 2^{A}, validity bit deciding unit 410 indicates the validity bits of boundary value data BVD using first logic values, and indicates other bits of boundary value data BVD using second logic values.

Saturation detecting unit 420 receives data signal DATA, determines whether data signal DATA is saturated in response to boundary value BVD, and outputs the result as a detection signal SATDET.

More specifically, saturation detecting unit 420 determines whether data signal DATA is saturated by extracting and assessing the upper bits of data signal DATA corresponding to the validity bits of boundary value data BVD.

When the most significant bit (MSB) of data signal DATA is set to the first logic value, and if at least one bit among the bits of the data corresponding to the validity bits of boundary value data BVD is set to the second logic value, it is determined that data signal DATA is saturated. When the MSB of data signal DATA is set to the second logic value, and if at least one bit among the bits of the data corresponding to the validity bits of boundary value data BVD is set to the first logic value, it is determined that data signal DATA is saturated.

If data signal DATA is saturated, then saturation detecting unit 420 sets detection signal SATDET to the first logic value. If data signal DATA is not saturated, then detection signal SATDET is set to the second logic value.

Limit generating unit 430 outputs a maximum limit UPLIMIT and a minimum limit LOLIMIT in response to boundary value data BVD. Maximum limit UPLIMIT is an inverted copy of boundary value data BVD. Minimum limit LOLIMIT is equal to boundary value data BVD.

Selecting unit 440 outputs one among data signal DATA, maximum limit UPLIMIT, and minimum limit LOLIMIT, in response to data signal DATA and detection signal SATDET. More specifically, selecting unit 440 clips its output by selecting minimum limit LOLIMIT if the MSB of data signal DATA is set to the first logic value and detection signal SATDET is set to the first logic value. If the MSB of data signal DATA is set to the second logic value and detection signal SATDET is set to the first logic value, then selecting unit 440 clips its output by selecting maximum limit UPLIMIT. If detection signal SATDET is set to the second logic value, then selecting unit 440 outputs data signal DATA.

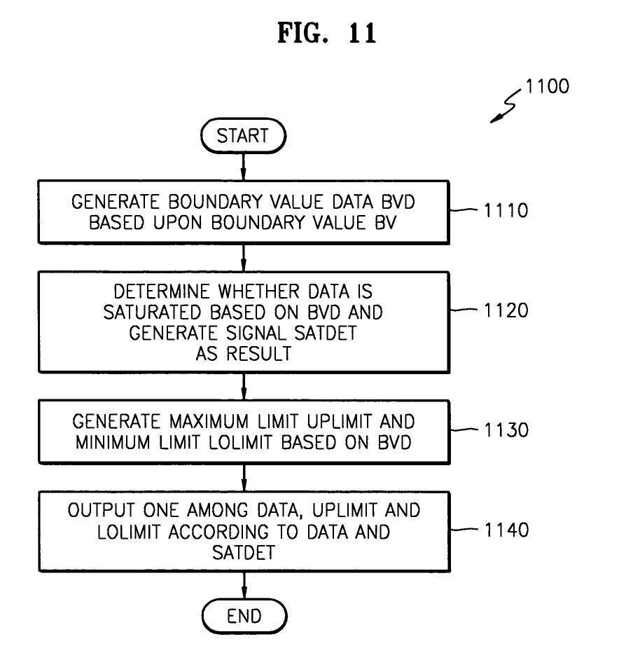

FIG. 11 is a flowchart 100 describing a method of managing saturation according to an embodiment of the present invention.

The method described by flowchart 1100 corresponds to the operation of saturation manager 400 of FIG. 4. Hence, the operation of the saturation manager 400 will be described with reference to steps S1110-S1140 of FIG. 11.

In first step 1110, in response to boundary value BV, validity bit deciding unit 410 generates boundary value data BVD, which is used to determine whether data signal DATA is saturated.

Boundary value BV is set by a user, and from BV maximum limit UPLIMIT and minimum limit LOLIMIT can be determined. Since maximum limit UPLIMIT and minimum limit LOLIMIT are constrained to being the data bus width of the processor in which saturation manager 400 is included, boundary value BV is not necessarily unlimited. Boundary value BV is typically less than (but can be equal to) the data bus width of the processor.

For example, if the data bus width is 8 bits and a user desires to set the range of validity values for data signal DATA to be from −32 to 31, i.e., −2⁵ to 2⁵−1, the user sets boundary value BV to 32. The number “32” can be expressed with as few as 6 bits in binary and with 8 bits looks like “0010 0000”.

When the processor that incorporates the saturation manager 400 includes a data bus of K bits and boundary value BV is expressed as 2^{A}, the validity bits correspond to the upper (K−A) (or, in other words, the K−A most significant bits) bits of boundary value data BVD. Here K and A are positive integers and K≧A. In the example above, K is equal to 8 and A is equal to 5, so the validity bits correspond to the upper 3 bits of boundary value data BVD.

Validity bit deciding unit 410 outputs the validity bits of boundary value data BVD as first logic values and the other bits of boundary value data BVD as second logic values. For convenience of explanation, hereafter the first logic value is assumed to be “1” and the second logic value is assumed to be “0”. However, the first logic value and the second logic value may be set to other values, e.g., the reverse of the foregoing values.

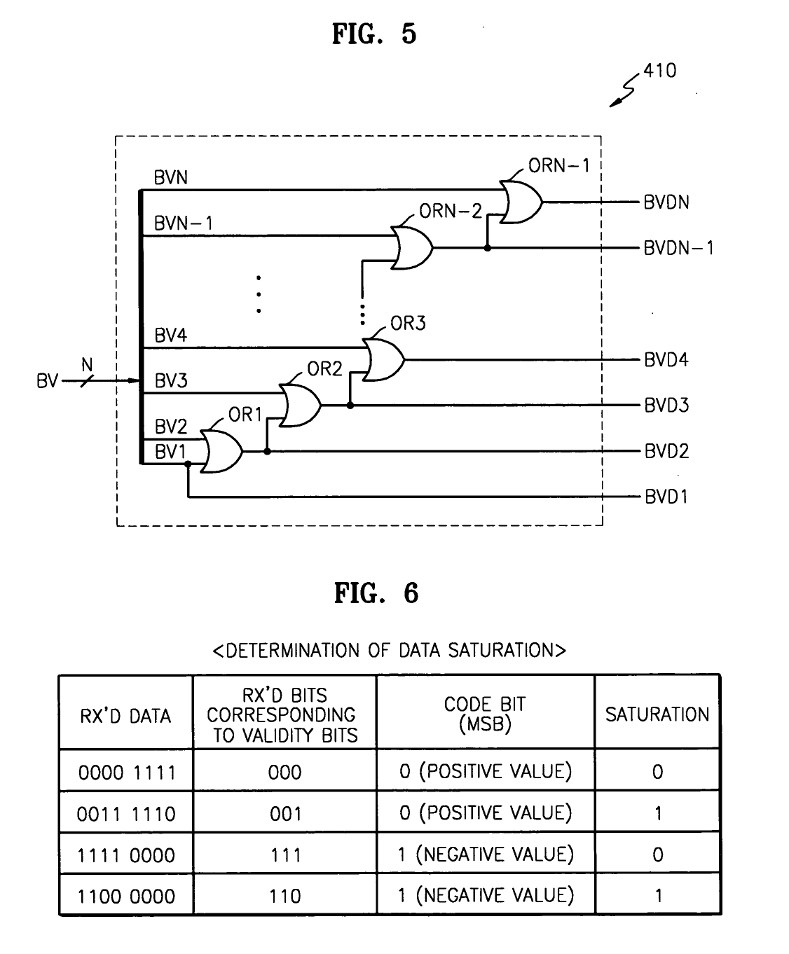

Continuing the example of K=8 and A=5, validity bit deciding unit 410 outputs binary “1110 0000” as boundary value data BVD. FIG. 5 is a circuit diagram illustrating in more detail an example of the validity bit deciding unit of FIG. 4, according to an embodiment of the present invention.

Referring to FIG. 5, boundary value BV is comprised of N bits and expressed as 2^{A}, where N is a positive integer, N≦K and N≧A. Validity bit deciding unit 410 includes first through N−1^{th} logical OR gates OR1 through ORN−1. For convenience of explanation, hereafter it is assumed that boundary value BV is comprised of 8 bits and expressed as 2⁵, although this is non-limiting as N and A can be other values.

First OR gate OR1 performs an OR operation on the least significant bit (LSB) of boundary value BV, e.g., a first bit BV1, and a second bit BV2. Second through N−1^{th} OR gates OR2 through ORN−1 do the following: receive corresponding ones of the third through N^{th} bits BV3 through BVN, respectively; and each performs an OR operation on the received one bit and the output of a previous OR gate, respectively. First bit BV1 of boundary value BV is output as the LSB of boundary value data BVD, i.e., a first bit BVD1. The outputs of first through N−1^{th} OR gates OR1 through ORN−1 are output as second through N^{th} bits BVD2 through BVDN of boundary value data BVD.

In other words, first bit BV1 of boundary value BV is output as first bit BVD1 of boundary value data BVD. The output of first OR gate OR1 is output as second bit BVD2 of boundary value data BVD. In this way, the output of N−1^{th} OR gate ORN−1 is output as Nth bit BVDN of boundary value data BVD. Validity bit deciding unit 410 sets bits BVN through BVA to be “1s” and bits BVA-1 through BV1 to be “0s”.

In next step 1120, according to boundary value data BVD, saturation detecting unit 420 generates detection signal SATDET which indicates whether or not data signal DATA is saturated. Step 1120 corresponds to the operation of saturation detecting unit 420.

Saturation detecting unit 420 receives data signal DATA, determines according to boundary value data BVD whether data signal DATA is saturated, and outputs the result of the determination as detection signal SATDET. If data signal DATA is saturated, then detection signal SATDET is set to the first logic value. If data signal DATA is not saturated, then detection signal SATDET is set to the second logic value.

Saturation detecting unit 420 determines whether data signal DATA is saturated by extracting and assessing the upper bits of data signal DATA corresponding to the validity bits of boundary value data BVD, namely the upper (K−A) bits (again, alternately described as K−A most significant bits) of data signal DATA.

For convenience of explanation, an example is assumed in which the number of validity bits is 3 and data signal DATA takes, e.g., the value 96, which is binary “0110 0000”. Then saturation detecting unit 420 determines whether data signal DATA is saturated using the upper 3 bits of data signal DATA, which in the example are “011”. More specifically, when the MSB of data signal DATA is the first logic value and at least one bit among bits of data signal DATA corresponding to the other validity bits of boundary value data BVD is the second logic value (such as is true in the example), it is determined that data signal DATA is saturated.

FIG. 6 illustrates a table for explaining the determination of data saturation, according to an example implementation (where N=8 and A=5) of an embodiment of the present invention. Referring to FIG. 6, if the bits of data signal DATA corresponding to the validity bits of boundary value data BVD are “111”, it is determined that data signal DATA indicates a negative value that is not saturated. Thus, detection signal SATDET is output as the second logic value, i.e., “0”. But when the bits of data signal DATA corresponding to the validity bits of boundary value data BVD are “110”, it is determined that data signal DATA indicates a negative value that is saturated. Thus, detection signal SATDET is output as the first logic value, i.e., “1”.

In FIG. 6, when the MSB of data signal DATA is the second logic value and at least one bit among bits of data signal DATA corresponding to the other validity bits of boundary value data BVD is the first logic value, it is determined that data signal DATA indicates a positive value that is saturated. If the bits of data signal DATA corresponding to the validity bits of boundary value data BVD are “000”, it is determined that data signal DATA indicates positive value that is not saturated. Thus, detection signal SATDET is output as the second logic value, i.e., “0”.

As another example, when the bits of data signal DATA corresponding to the validity bits of boundary value data BVD are “001”, it is determined that data signal DATA indicates a positive value that is saturated. Thus, detection signal SATDET is output as the first logic value, i.e, “1”.

Returning to the discussion of step S1120 (where data signal DATA in the example is binary “0110 0000”), bits of data signal DATA corresponding to the validity bits of boundary value data BVD are “011”. Accordingly, it is determined that data signal DATA indicates a positive value that is saturated.

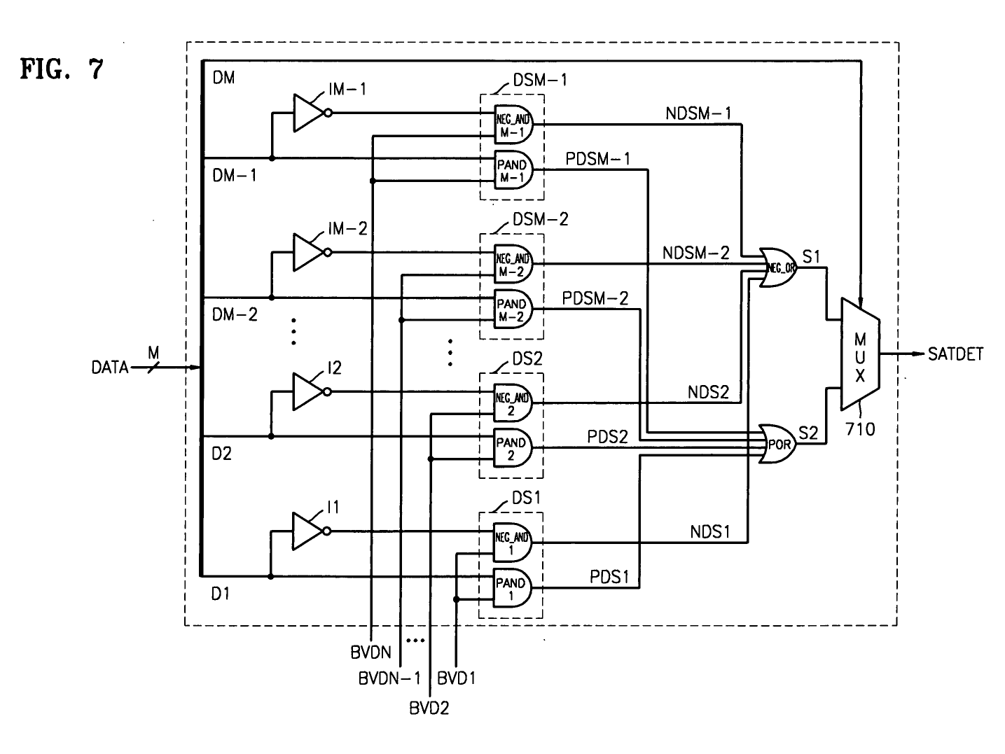

FIG. 7 is a block diagram illustrating in more detail an example of saturation detecting unit 420, according to an embodiment of the present invention.

Referring to FIG. 7, when data signal DATA is comprised of M bits, saturation detecting unit 420 includes first through M−1^{th} inverters I1 through IM−1, first through M−1^{th} detection signal generating units DS1 through DSM−1, a logical OR gate NEG_OR relating to negative values of data signal DATA, a logical OR gate POR relating to positive values of data signal DATA, and a selecting unit 710.

First through M−1^{th} inverters 11 through IM−1 invert logic values of first through M−1^{th} bits of data signal DATA. First through M−1^{th} detection signal generating units DS1 through DSM−1 receive corresponding bits among first through M−1^{th} bits of data signal DATA, inverted logic values of first through M−1^{th} bits of data signal DATA, and corresponding bits of boundary value data BVD, and generate first through M−1^{th} positive value detection signals PDS1 through PDSM−1 and first through M−1^{th} negative value detection signals NDS1 through NDSM−1.

First through M−1^{th} detection signal generating units DS1 through DSM−1 include: logical AND gates PAND1 through PANDM−1, respectively, relating to positive values of data signal DATA: and logical AND gates NEG_AND1 through NEG_ANDM−1, respectively, relating to positive values of data signal DATA. Positive value AND gates PAND1 through PANDM−1 perform AND operations on corresponding bits among first through M−1^{th} bits D1 through DM−1 of data signal DATA and corresponding bits BVD1 through BVDN of boundary value data BVD and generate positive value detection signals PDS1 through PDSM−1. Negative value AND gates NEG_AND through NEG_ANDM−1 perform AND operations on inverted logic values of first through M−1^{th} bits Dl through DM−1, respectively, of data signal DATA and corresponding bits BVD1 through BVDN of boundary value data BVD, respectively, and generate negative value detection signals NDS1 through NDSN−1, respectively.

Negative value OR gate NEG_OR performs an OR operation on first through M−1^{th} negative value detection signals NDS1 through NDSM−1 and outputs a first signal S1. Positive value OR gate POR performs an OR operation on first through M−1^{th} positive value detection signals PDS1 through PDSM−1 and outputs a second signal S2.

If the MSB of data signal DATA is the first logic value, selecting unit 710 selects and outputs first signal S1 as detection signal SATDET. If the MSB of data signal DATA is the second logic value, selecting unit 710 selects and outputs second signal S2 as detection signal SATDET.

Recalling the example in which it is assumed that data signal DATA is “0110 0000”, the example is now extended by assuming that boundary value data BVD is “1110 0000”. Once data signal DATA and boundary value data BVD are input to saturation detecting unit 420, first signal S1 becomes “0” and second signal S2 becomes “1”. Since the MSB of data signal DATA is the second logic value, i.e., “0”, selecting unit 710 outputs second signal S2 as detection signal SATDET.

The number of bits of data signal DATA may be greater than the number of bits boundary value data BVD. In this case, one or more binary “1” values can be added after the MSB of boundary value data BVD (or in other words, BVD can be padded with one or more values of “1” above its MSB) such that the number of bits of data signal DATA is identical to that of boundary value data BVD.

Since saturation detecting unit 420 of FIG. 7 merely includes OR gates, AND gates, and inverters, it has an advantage of simpler configuration when contrasted with Background Art saturation management apparatus 300 (that uses, among other things, two comparators 330 and 340 each of which is implemented by an N×N decrementer, etc.)

In the next step S1130, maximum limit UPLIMIT and minimum limit LOLIMIT are generated. Step 1130 corresponds to the operation of limit generating unit 430.

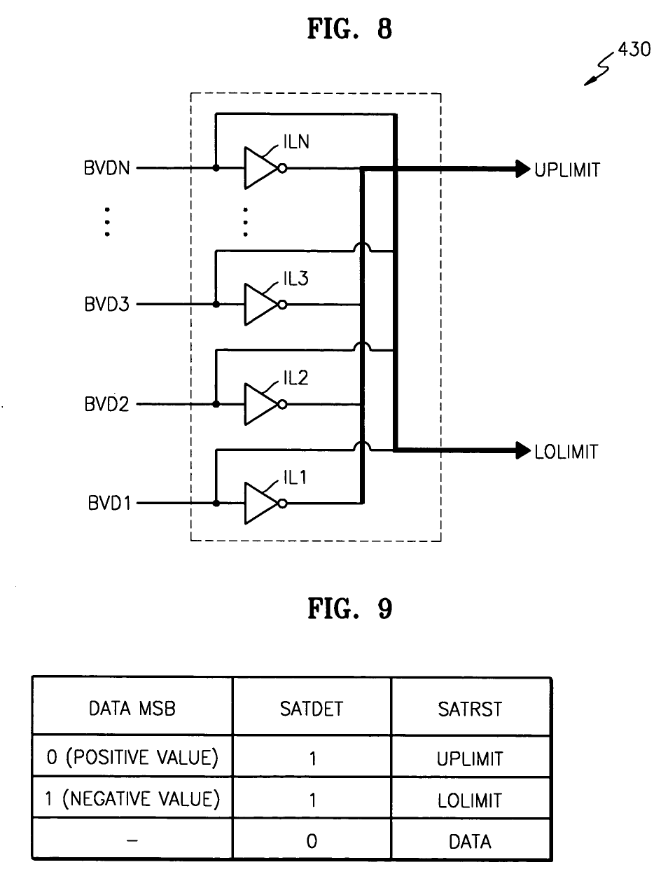

FIG. 8 is a circuit diagram illustrating in more detail an example of limit generating unit 430, according to an embodiment of the present invention.

In developing the present invention, the following problem with the Background Art was recognized and the path to a solution thereof determined. To obtain its boundary values, saturation management method 300 subtracts “1” from boundary value BV, inverts each bit, and adds “1” to each inverted bit to obtain the 2's complement, which creates the problems of complicated configuration and operation. To, e.g., reduce cost and/or improve manufacturability, etc., a less complicated technique and associated circuitry are needed for obtaining boundary values. Embodiments of the present invention provide such a relatively less complicated technique and associated circuitry for obtaining the boundary values.

Referring to FIG. 8, limit generating unit 430 outputs maximum limit UPLIMIT and minimum limit LOLIMIT based upon boundary value data BVD. Maximum limit UPLIMIT is an inverted copy of boundary value data BVD. Minimum limit LOLIMIT is equal to boundary value data BVD.

Saturation manager 400 clips data signal DATA to maximum limit UPLIMIT or minimum limit LOLIMIT when data signal DATA is saturated. For example, if boundary value BV is 32, which is binary “0010 0000” and if boundary value data BVD is “1110 0000”, then maximum limit UPLIMIT is an inverted copy of boundary value data BVD, namely 31 and binary “0001 1111” and minimum limit LOLIMIT is equal to boundary value data BVD, namely binary “1110 0000” which is −32.

The configuration of limit generating unit 430 is simple. Limit generating unit 430 includes first through N^{th} inverters IL1 through ILN that invert corresponding bits of boundary value data BVD and output the inverted bits as maximum limit UPLIMIT. Minimum limit LOLIMIT is equal to boundary value data BVD.

In step S1140, selecting unit 440 outputs one among data signal DATA, maximum limit UPLIMIT, and minimum limit LOLIMIT according to data signal DATA and detection signal SATDET.

FIG. 9 is a table for explaining the operation of selecting unit 440, according to an embodiment of the present invention.

Referring to FIG. 9, selecting unit 440 outputs as resultant signal SATRST minimum limit LOLIMIT if the MSB of data signal DATA is the first logic value (again, assumed to be “1”) and detection signal SATDET is the first logic value.

If detection signal SATDET is the first logic value, then it is determined that data signal DATA is saturated. If the MSB of data signal DATA is the first logic value (and SATDET=“1”), then data signal DATA is negative and selecting unit 440 accordingly outputs minimum limit LOLIMIT as value of resultant data SATRST. If the MSB of data signal DATA is the second logic value (again, assumed to be “0”) (and SATDET=“0”), then the detection data signal DATA is positive and selecting unit 440 accordingly outputs maximum limit UPLIMIT as value of resultant data SATRST.

If detection signal SATDET is the second logic value, then data signal DATA is not saturated. Accordingly, selecting unit 440 then outputs data signal DATA, irrespective of whether the MSB of data signal DATA is the first logic value or the second logic value.

FIG. 11 shows step S1130 as occurring subsequent to step S1120. As review of FIG. 4 reveals, step S1130 alternatively can be performed in parallel with step S1120 or before step S1120.

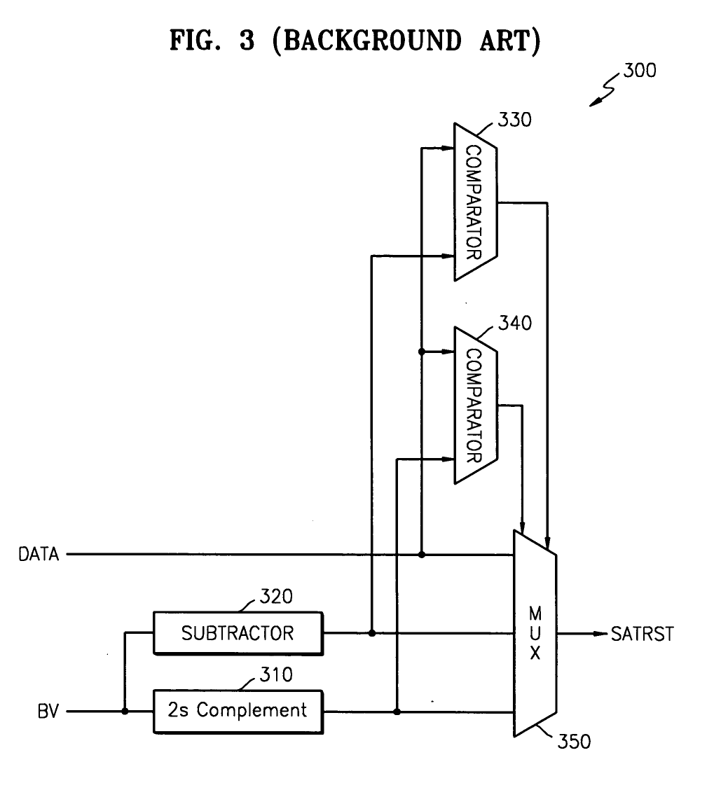

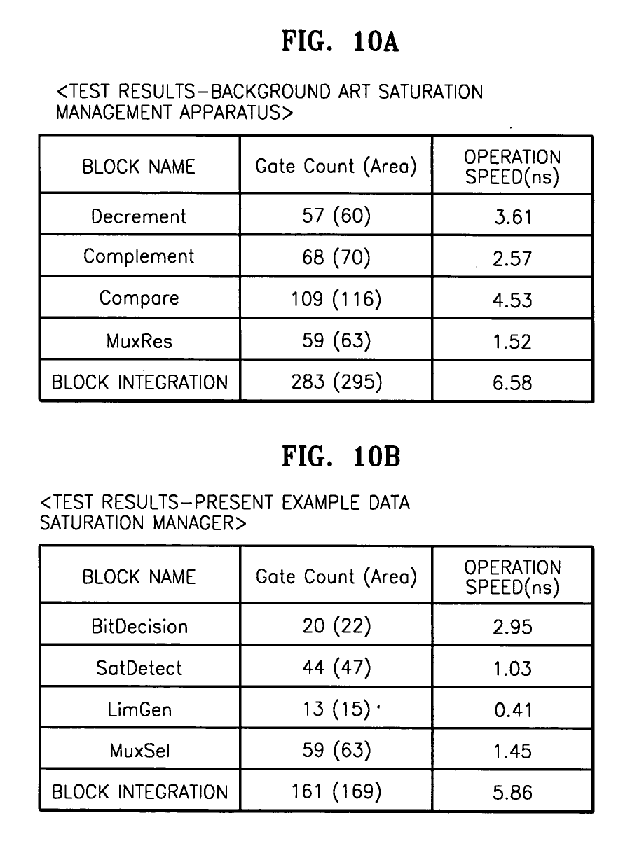

FIG. 10A is a table listing results from testing the operation speeds of Background Art saturation management apparatus 300 of FIG. 3. In contrast, FIG. 10B is a table listing results from testing an example implementation of an apparatus which incorporates saturation manager 400 according to an embodiment of the present invention.

In the example testing of FIGS. 10A and 10B, data signal DATA is comprised of 18 bits and boundary value BV is comprised of 16 bits. FIG. 10A lists the speeds of a decrement operation, a complement operation, a comparison operation, and a multiplexing operation and the corresponding indications of area needed for implementing such operations, respectively. FIG. 10B lists the speeds of validity bit decision (by unit 410), saturation detection (by unit 420), limit generation (by unit 430), and selection (by unit 440) and corresponding indications of area needed for such operations/units, respectively. As shown in FIGS. 10A and 10B, saturation manager 400 is superior to Background Art saturation management apparatus 300 of FIG. 3.

According to embodiments of the present invention, it is possible for a user to dynamically set the range of operation and yet still reduce the time and power consumption necessary for saturation management relative to the Background Art.

While the present invention has been particularly shown and described with reference to an example embodiment thereof, it will be understood by those of ordinary skill in the art that various changes in form and details may be made therein without departing from the spirit and scope of the invention.

What is claimed is:

1. A data saturation manager comprising:
a validity bit deciding circuit to generate boundary value data based upon a boundary value;
a saturation detecting circuit to determine whether received data is saturated according to the boundary value data, and to output a detection signal as a result;
a limit generating circuit to generate a maximum limit and a minimum limit based upon the boundary value data; and
a selecting circuit to output one among the received data, the maximum limit and the minimum limit according to the received data and the detection signal.

2. The saturation manager of claim 1, wherein a number of bits representing the boundary value is less than a width in bits of a data bus for a processor in which including the saturation manager can be incorporated.

3. The saturation manager of claim 2, wherein:
the saturation detecting circuit is operable to determine saturation based upon validity bits of the boundary value data; and,
the validity bits correspond, if the data bus is K bits and if the boundary value is expressed as 2^{A}, to the upper K−A bits of the boundary value data, where K and A are positive integers and K≧A.

4. The saturation manager of claim 3, the validity bit deciding circuit outputs the validity bits of the boundary value data as first logic values and the other bits of the boundary value data as second logic values.

5. The saturation manager of claim 1, wherein:
the boundary value has N bits and is expressed as 2^{A}, where N and A are positive integers and N≧A;
the validity bit deciding circuit includes first through N−1^{th} logical OR gates;
the first OR gate performs an OR operation on the least significant first bit of the boundary value, and a second bit of the boundary value;
the second through N−1^{th} OR gates receive corresponding bits among the third through N^{th} bits of the boundary value and perform OR operations thereon and on the output of a previous OR gate, respectively;
the first bit of the boundary value is output as least significant first bit of the boundary value data, and the outputs of the first through N−1^{th} OR gates are output as second through N^{th} bits, respectively, of the boundary value data.

6. The saturation manager of claim 1, wherein:
the saturation detecting circuit is operable to determine whether the received data is saturated by assessing the upper bits of data corresponding to validity bits of the boundary value data such that
when the most significant bit (MSB) of the received data is a first logic value and at least one bit among the bits of the received data corresponding to one or more other ones of the validity bits is a second logic value, then the received data is determined to be saturated, and
when the MSB of the received data is the second logic value and at least one bit among the bits of the received data corresponding to the one or more other validity bits is the first logic value, then the received data is determined to be saturated.

7. The saturation manager of claim 6, wherein if the received data is saturated, then the detection signal is set to the first logic value, but if the received data is not saturated, then the detection signal is set to the second value.

8. The saturation manager of claim 1, wherein:
the saturation detecting unit for received data;
first through M−1^{th} inverters to invert a least significant first bit of the data through an M−1^{th} bit of the data, respectively;
first through M−1^{th} detection signal generating circuits, which receive corresponding bits among first through M−1^{th} bits of the data and the inverted bits thereof and generate first through M−1^{th} positive value detection signals and first through M−1^{th} negative value detection signals;
a negative value logical OR gate to perform an OR operation on the first through M−1^{th} negative value detection signals and output a first signal;
a positive value logical OR gate to perform an OR operation on the first through M−1^{th} positive value detection signals and output a second signal; and
a selecting circuit, which, if the most significant bit (MSB) of the received data is a first logic value, is operable to select and output the first signal as the detection signal, and, if the MSB of the data is a second logic value, is operable to select and output the second signal as the detection signal.

9. The saturation manager of claim 8, wherein each of first through M−1^{th} detection signal generating units includes:
a positive value logical AND gate to perform an AND operation on the corresponding bit among the first through M−1^{th} bits of the received data and the corresponding bit of the boundary value data and to generate the positive value detection signal; and
a negative value logical AND gate to perform an AND operation on the inverted bit of the corresponding bit among the first through M−1^{th} bits of the received data and the corresponding bit of the boundary value data and generates the negative value detection signal.

10. The saturation manager of claim 1, wherein the maximum limit is an inverted value of the boundary value data, and the minimum limit is equal to the boundary value data.

11. The saturation manager of claim 1, wherein the limit generating unit includes first through N^{th} inverters to invert bits of the boundary value data and output the inverted bits as the maximum limit.

12. The saturation manager of claim 8, wherein the selecting unit is operable to output the minimum limit if the MSB of the received data is the first logic value and the detection signal is the first logic value, to output the maximum limit if the MSB of the received data is the second logic value and the detection signal is the first logic value, and to output the received data if the detection signal is the second logic value.

13. A method of managing saturation of data, the method comprising:
generating boundary value data based upon a boundary value;
determining whether input data is saturated according to the boundary value data and generating a detection signal as a result;
generating a maximum limit and a minimum limit based upon the boundary value data; and
selecting as an output signal one among the input data, the maximum limit and the minimum limit, according to the input data and the detection signal.

14. The method of claim 13, wherein a number of bits representing the boundary value is less than a width in bits of a data bus for a processor in which the method is implemented.

15. The method of claim 13, wherein:
the determining of saturation is based upon validity bits of the boundary value data; and the validity bits correspond, if the data bus is K bits and the boundary value is expressed as 2^{A}, to the upper K−A bits of the boundary value data, where K and A are positive integers and K≧A.

16. The method of claim 15, wherein the validity bits of the boundary value data are set to first logic values and other bits of the boundary value data are set to second logic values.

17. The method of claim 13, wherein:
the boundary value has N bits and is expressed as 2^{A}, where N and A are positive integers and N≧A;
wherein the generating of boundary value data includes
performing a first OR operation on the least significant first bit of the boundary value and a second bit of the boundary value,
outputting the first bit of the boundary value as the least significant first bit of the boundary value data,
outputting the first OR operation result as a second bit of boundary value data,
performing second through N−1 OR operations on the corresponding bits of the boundary value and on the results of corresponding previous OR-operations, respectively, and
outputting the second through N−1 OR-operation results as third through N bits, respectively, of the boundary value data.

18. The method of claim 13, wherein the determining of whether the input data is saturated includes:
assessing the upper bits of the input data corresponding to the validity bits of the boundary value data; and
treating the input data as being saturated
when the most significant bit (MSB) of the data is a first logic value and at least one bit among bits of the input data corresponding to one or more other ones of the validity bits of the boundary value data is a second logic value, and
when the MSB of the input data is the second logic value and at least one bit among bits of the input data corresponding to the one or more other ones of the validity bits is the first logic value.

19. The method of claim 13, wherein the generating of the maximum and minimum limits forms the maximum limit by inverting the boundary value data, and uses the boundary value data as the minimum limit.

20. The method of claim 13, wherein the selecting as an output signal chooses as follows:
if the most significant bit (MSB) of the input data is a first logic value and the detection signal is the first logic value, then choose the minimum limit as the output signal;
if the MSB of the input data is a second logic value and the detection signal is the first logic value, then choose the maximum limit as the output signal; and
if the detection signal is the second logic value, then choose the input data as the output signal.
